(19) United States
(12) Patent Application Publication
(10) Pub. No.: US 2016/0068006 A1
(43) Pub. Date: Mar. 10, 2016

(54) KNOCK-TYPE APPLICATOR

(71) Applicant: V SPARK CO., LTD., Saitama-shi, Saitama (JP)

(72) Inventor: Masayuki KAWASAKI, Soka-shi, Saitama (JP)

(21) Appl. No.: 14/785,137

(22) PCT Filed: Apr. 18, 2014
(86) PCT No.: PCT/JP2014/061028

§ 371 Date: Oct. 16, 2015

(30) Foreign Application Priority Data
Apr. 18, 2013 (JP) 2013-087071

(51) Int. Cl. B43K 5/17; B43K 8/02; B43K 24/08

(52) U.S. Cl. CPC B43K 5/17; B43K 24/08; B43K 8/02

(57) ABSTRACT

A knock-type writing instrument including a refill, an outer tube housing the refill, a refill moving mechanism allows movement of the refill between a projecting state in which a front end of the refill projects from the outer tube and a housed state in which the front end of the refill is housed in the outer tube, an opening and closing device disposed in the outer tube and provided with an opening and closing port, and a release device provided at a front-side opening end of the outer tube. By the opening and closing device abutting against the release device, the opening and closing port assumes an open state in which the refill can pass therethrough. By the opening and closing device moving away from the release device, the opening and closing port assumes a closed state.

### TECHNICAL FIELD

The present invention relates to a knock-type applicator.

### BACKGROUND ART

Knock-type writing instruments and knock-type makeup tools in each of which a refill is movable between a state in which a nib is projected from an outer tube to write and a housed state in which the nib is housed in the outer tube have been known. (Hereinafter, the knock-type writing instruments and the knock-type makeup tools are collectively referred to as knock-type applicators.)

For example, the knock-type applicator described in Japanese Patent Application Laid-Open No. 2005-22138 includes an inner cap for forming a sealed space around the nib in the housed state. Since this inner cap is provided with a slit, the nib directly abutting against the inner cap causes the slit to be in an open state in which the nib can pass through the slit. On the other hand, the nib moved away from the inner cap causes the slit to be in a closed state. When the slit is in the closed state, the sealed space is formed around the nib.

The inner cap having such a slit can prevent ink from being dried in the nib even when the housed state is kept for a long time. Thus, it is possible to make the ink last long.

### SUMMARY OF INVENTION

### Technical Problem

In the above-described knock-type writing instrument, however, the inner cap needs to be pushed directly by the nib in order to open and close the slit. Thus, when the refill is reciprocated multiple times between the projecting state and the housed state, the nib wears every time the inner cap is pushed thereby. Thus, the product life is shortened.

Moreover, when the inner cap is pushed directly by the nib, ink is attached to the inner cap. Thus, in addition to such an ink stain in the inner cap, a problem arises such as that the ink attached to the inner cap hinders a smooth opening and closing operation of the slit. In particular, the ink attached to the vicinity of the slit prevents the inner cap from transitioning to its predetermined closed state. In such a case, as a result of being left in the housed state, the ink is dried and it is therefore impossible to make the ink last long.

This applies not only to the knock-type writing instruments but also to the knock-type makeup tools.

In consideration of such circumstances, it is an object of the present invention to provide a knock-type applicator having a long product life.

### Solution to Problem

Owing to hard studies by the present inventor, the above-described object can be achieved by the following means.

The present invention provides a knock-type applicator including an applicator body having a paint outlet part for outputting a paint housed in a paint housing part to the outside, the knock-type applicator configured to feed the paint outputted from the paint housing part to a material to be applied by causing the paint outlet part to abut against the material to be applied. The knock-type applicator includes: an outer tube that houses the applicator body; an applicator body moving mechanism configured to allow the applicator body to be movable between a housed state in which the paint outlet part is positioned in the outer tube and a projecting state in which the paint outlet part is projected from the outer tube; and a paint outlet housing space forming mechanism configured to form a space in which the paint outlet part is housed. When the applicator body is in the housed state, the space in which the paint outlet part is housed assumes a sealed state. When the applicator body is in the projecting state, the space in which the paint outlet part is housed assumes an open state opened to an external space.

When the applicator body is in the housed state, a pressure change in the space in which the paint outlet part is housed is preferably restricted. Moreover, when the applicator body is in the housed state, a volume change in the space in which the paint outlet part is housed is preferably restricted.

A state in which a relative position between the applicator body and the paint outlet housing space forming mechanism is changeable and a state in which the relative position is restricted from changing is preferably switchable therebetween.

Moreover, switching between the state in which the relative position between the applicator body and the paint outlet housing space forming mechanism is changeable and the state in which the relative position is restricted from changing is preferably performed by relative movement of the applicator body with respect to the outer tube.

When the applicator body is in the housed state, a relative position between the applicator body and the paint outlet housing space forming mechanism is preferably restricted from changing. Moreover, when the paint outlet part is in the projecting state, the relative position between the applicator body and the paint outlet housing space forming mechanism is preferably changeable. Furthermore, when the applicator body is in the housed state, the relative position between the outer tube and the paint outlet housing space forming mechanism is preferably changeable. When the applicator body is in the projecting state, the relative position between the outer tube and the paint outlet housing space forming mechanism is preferably restricted from changing.

The paint outlet housing space forming mechanism preferably includes: an opening and closing device having an opening and closing port configured to allow the space in which the paint outlet part is housed to be switchable between the sealed state and the open state; and an airtight tube having the opening and closing device at one of opening ends thereof and the applicator body inserted from the other one of the opening ends thereof. The opening and closing device and the airtight tube are preferably fixed to each other.

The paint outlet housing space forming mechanism preferably includes: an opening and closing device having an opening and closing port configured to allow the space in which the paint outlet part is housed to be switchable between the sealed state and the open state; and an airtight tube having the opening and closing device at one of opening ends thereof and the applicator body inserted from the other one of the opening ends thereof. The opening and closing device is preferably formed integrally with the airtight tube.

The paint outlet housing space forming mechanism preferably includes an opening and closing device having an opening and closing port configured to allow the space in which the paint outlet part is housed to be switchable between the sealed state and the open state and formed in a slit shape.

The present invention provides a knock-type applicator including an applicator body having a paint outlet part for outputting a paint housed in a paint housing part to the outside, the knock-type applicator configured to feed the paint outputted from the paint housing part to a material to be applied by causing the paint outlet part to abut against the material to be applied. The knock-type applicator includes: an outer tube that houses the applicator body; an applicator body moving mechanism configured to allow the applicator body to be movable between a housed state in which the paint outlet part is positioned in the outer tube and a projecting state in which the paint outlet part is projected from the outer tube; a paint outlet housing space forming mechanism configured to form a space in which the paint outlet part is housed; and an opening and closing switching mechanism configured to allow the space in which the paint outlet part is housed to be switchable between a sealed state and an open state. The paint outlet housing space forming mechanism includes an opening and closing device having an opening and closing port configured to allow the space in which the paint outlet part is housed to be switchable between the sealed state and the open state and formed in a slit shape. The opening and closing switching mechanism includes a release device that performs an opening and closing operation of the opening and closing device. The opening and closing port assumes an open state in which the paint outlet part can pass therethrough by the opening and closing operation.

The opening and closing device is preferably disposed in the outer tube so as to traverse a moving path of the paint outlet part between the housed state and the projecting state, and the release device is preferably disposed at a position in the outer tube closer to one side than the opening and closing device so as to be deviated from the moving path of the paint outlet part, and performs relative movement to the opening and closing device. Moreover, the relative movement of the release device with respect to the opening and closing device is preferably performed along with movement of the applicator body.

The knock-type applicator preferably further includes: an airtight tube having the opening and closing device at one of opening ends thereof and the applicator body inserted from the other one of the opening ends thereof; and a sealing part provided in a gap between the airtight tube and the applicator body, and the opening and closing device in a closed state, the airtight tube, and the sealing part preferably cause the space in which the paint outlet part is housed to be a sealed space. Moreover, the applicator body moving mechanism preferably includes: an outer tube-side moving mechanism configured to allow the applicator body, together with the airtight tube, to be movable relative to the outer tube between an abutting position at which the opening and closing device abuts against the release device and a separated position at which the opening and closing device is away from the release device; and an airtight tube-side moving mechanism configured to allow the applicator body to be movable relative to the airtight tube between the housed state and the projecting state when the opening and closing port is turned to the open state by the abutting. Furthermore, the outer tube-side moving mechanism is preferably provided between the outer tube and the airtight tube, and the airtight tube-side moving mechanism is preferably provided between the airtight tube and the applicator body.

The knock-type applicator preferably includes an outer tube-side movement restricting member provided between the outer tube and the airtight tube, the outer tube-side movement restricting member restricting movement of the applicator body based on the outer tube-side moving mechanism, and the outer tube-side moving mechanism is preferably configured to allow the applicator body at the abutting position to be movable between a state in which the applicator body is locked with the outer tube-side movement restricting member and a state in which the applicator body is away from the outer tube-side movement restricting member.

When the applicator body is locked with the outer tube-side movement restricting member, movement of the applicator body based on the airtight tube-side moving mechanism preferably takes precedence over movement of the applicator body based on the outer tube-side moving mechanism. When the applicator body is away from the outer tube-side movement restricting member, movement of the applicator body based on the outer tube-side moving mechanism preferably takes precedence over movement of the applicator body based on the airtight tube-side moving mechanism. Moreover, when the applicator body moves from the separated position toward the abutting position, a resistance force generated in the airtight tube-side moving mechanism is preferably larger than a resistance force generated in the outer tube-side moving mechanism. When the applicator body in the projecting state moves toward the housed state, a resistance force generated in the airtight tube-side moving mechanism is preferably smaller than a resistance force generated in the outer tube-side moving mechanism.

The opening and closing device is preferably formed so as to protrude toward the other side.

The knock-type applicator preferably further includes an opening and closing port lock mechanism provided between the outer tube and the opening and closing device, the opening and closing port lock mechanism restricting the opening and closing port in the closed state from transitioning to the open state. When the applicator body is at the separated position, the opening and closing port lock mechanism preferably keeps the opening and closing device in the closed state. When the applicator body is at the abutting position, on the other hand, the opening and closing port lock mechanism preferably causes the opening and closing device to be capable of transitioning to the open state. Moreover, when the opening and closing port lock mechanism engages with an outer peripheral portion of the opening and closing device, the applicator body is preferably at the separated position. When the opening and closing port lock mechanism is away from the outer peripheral portion of the opening and closing device, on the other hand, the applicator body is preferably at the abutting position. Furthermore, the opening and closing port lock mechanism preferably includes a first locking member and a second locking member provided between the outer tube and the opening and closing device so as to be separated from each other, and the first locking member and the second locking member are preferably disposed so as to face each other with the opening and closing port in a straight shape interposed therebetween.

The knock-type applicator preferably includes: a one-side outer tube locking protrusion provided so as to protrude from an inner peripheral surface of the outer tube; an other-side outer tube locking protrusion provided so as to protrude from the inner peripheral surface of the outer tube at a position closer to the other side than the one-side outer tube locking protrusion; an applicator body locking protrusion protruded from the applicator body between the one-side outer tube locking protrusion and the other-side outer tube locking protrusion; a housed state-side biasing member for biasing the applicator body toward the housed state with both ends thereof abutting against the one-side outer tube locking protrusion and the applicator body locking protrusion; and a projecting state-side biasing member for biasing the applicator body toward the projecting state. The applicator body is preferably capable of transitioning between a buffer state in which the applicator body receives a biasing force toward the projecting state from the projecting state-side biasing member and a retracted state in which the applicator body is retracted from the buffer state.

Moreover, when the applicator body is in the projecting state, the projecting state-side biasing member is preferably away from the applicator body. When the applicator body is in the housed state, the projecting state-side biasing member preferably gives the biasing force toward the projecting state to the applicator body.

A housing space for housing the opening and closing device in the open state is preferably formed between the outer tube and the release device, and a communication hole configured to allow communication between the housing space and an external space of the outer tube is preferably formed in the outer tube.

### Advantageous Effects of Invention

According to the present invention, the knock-type applicator having a long product life can be provided.

### BRIEF DESCRIPTION OF DRAWINGS

FIG. 1A is a cross-sectional view illustrating an outline of a knock-type writing instrument.

FIG. 1B is an exploded cross-sectional view illustrating an outline of the knock-type writing instrument.

FIG. 1C is an enlarged cross-sectional view illustrating an outline of a front end portion of the knock-type writing instrument.

FIG. 2 is an exploded cross-sectional view illustrating an outline of the knock-type writing instrument.

FIG. 3(A) is a cross-sectional view illustrating an outline of the knock-type writing instrument when a refill is in a projecting state; and FIG. 3(B) is a cross-sectional view illustrating an outline of the knock-type writing instrument when the refill is in a projecting locked state.

FIG. 4A is an enlarged cross-sectional view illustrating an outline of the front end portion of the knock-type writing instrument at a first abutting position.

FIG. 4B is a cross-sectional view illustrating an outline of the knock-type writing instrument at a second abutting position.

FIG. 4C is an enlarged cross-sectional view illustrating an outline of the front end portion of the knock-type writing instrument at the second abutting position.

FIG. 5(A) is an enlarged cross-sectional view illustrating an outline of a rear end portion of the knock-type writing instrument when the refill is in a buffer state; and FIG. 5(B) is an enlarged cross-sectional view illustrating an outline of the rear end portion of the knock-type writing instrument when the refill is in a retracted state.

FIG. 6 is a cross-sectional view taken along line VI-VI, illustrating an outline of the inside of an outer tube.

FIG. 7A is an enlarged cross-sectional view illustrating an outline of an opening and closing device in a closed state.

FIG. 7B is an enlarged cross-sectional view illustrating an outline of the opening and closing device in an open state.

FIG. 8(A) is an enlarged cross-sectional view illustrating an outline of a rear end portion of a knock-type writing instrument when a refill is in a buffer state; and FIG. 8(B) is an enlarged cross-sectional view illustrating an outline of the rear end portion of the knock-type writing instrument when the refill is in a retracted state.

FIG. 9 is a cross-sectional view illustrating an outline of a refill.

FIG. 10 is an exploded cross-sectional view illustrating an outline of the refill.

FIG. 11 is a partial cross-sectional view illustrating an outline of the refill.

FIG. 12 is a cross-sectional view illustrating an outline of a pressure fluctuation buffering mechanism.

FIG. 13(A) is a cross-sectional view taken along line XIIIa-XIIIa, illustrating an outline of a protruded plate; and FIG. 13(B) is a cross-sectional view taken along line XIIIb-XIIIb, illustrating an outline of the protruded plate.

FIG. 14 is a side view illustrating an outline of the pressure fluctuation buffering mechanism.

### DESCRIPTION OF EMBODIMENTS

An embodiment of the present invention will be described below with reference to the accompanying drawings.

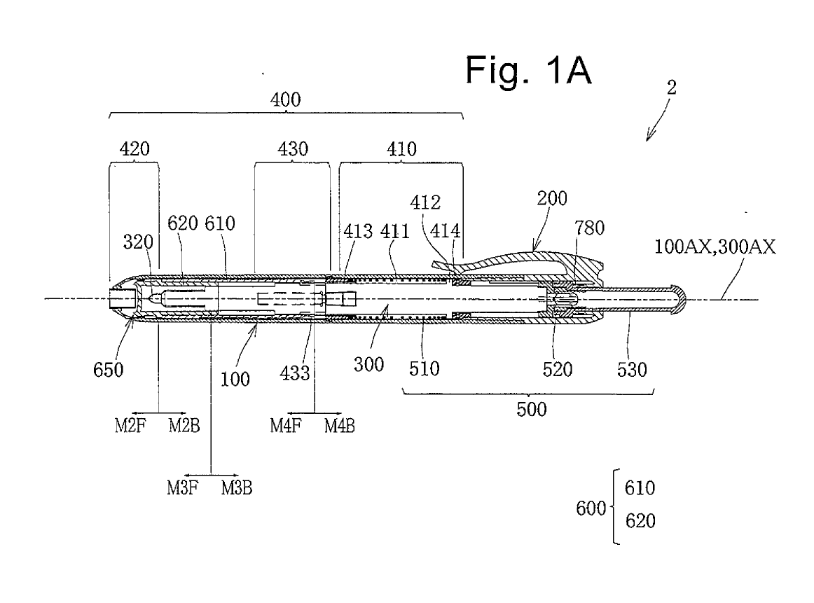

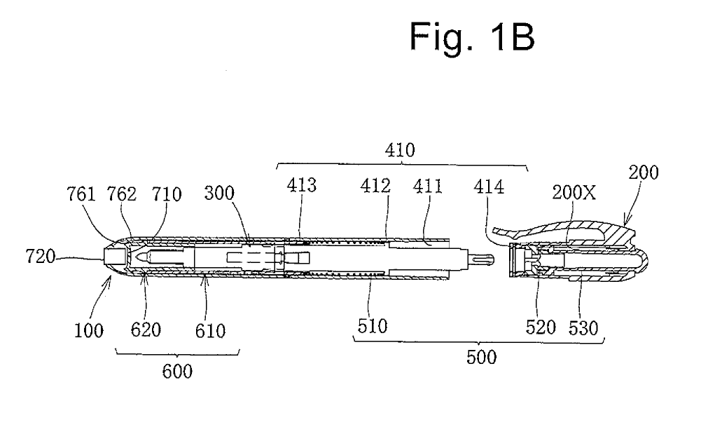

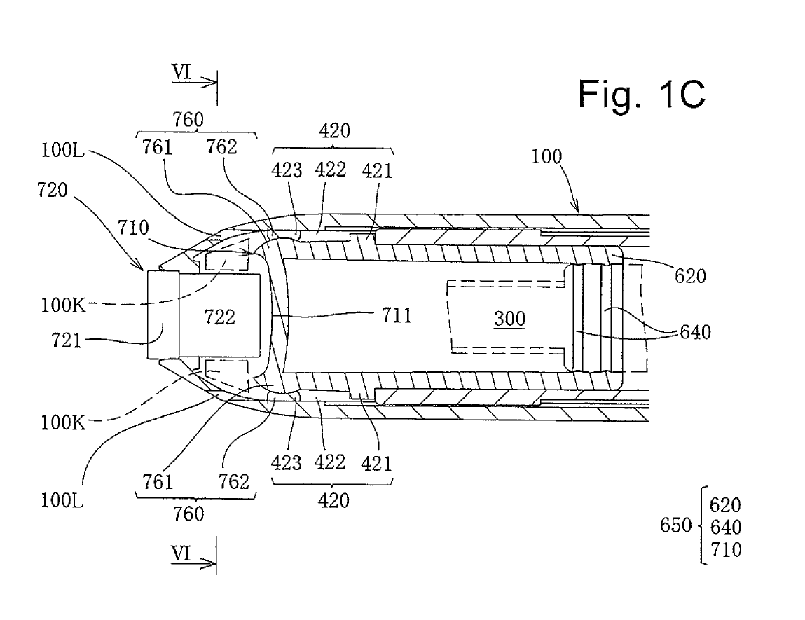

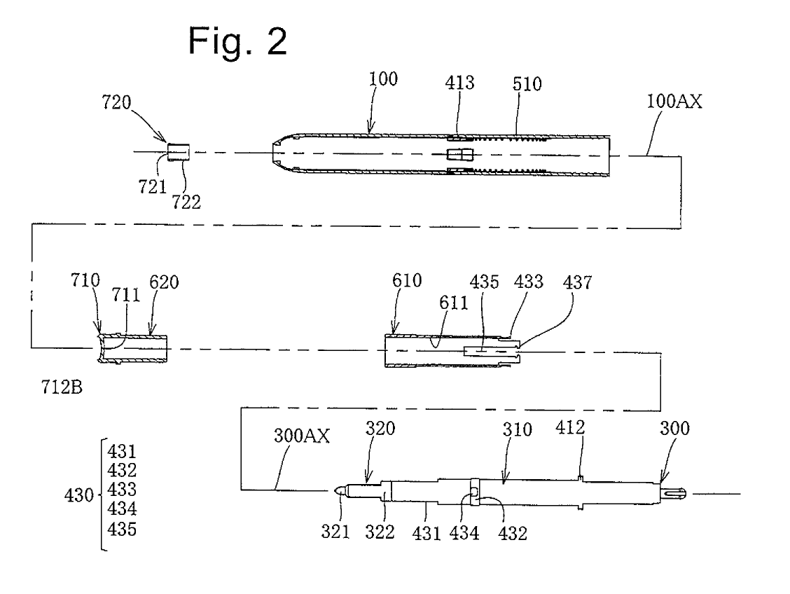

As shown in FIG. 1A, a knock-type writing instrument 2 includes: an outer tube 100; an end cap 200; a refill 300; a refill moving mechanism 400 configured to allow the refill 300 to move in a direction of an axis 300AX thereof (front-back direction); and a knocking operation mechanism 500 configured to allow a knocking operation in the direction of the axis 300AX of the refill 300. As shown in FIGS. 1A to 1B, a rear end portion of the outer tube 100 is attachable to a front end portion of the end cap 200. The attachment between the rear end portion of the outer tube 100 and the front end portion of the end cap 200 integrates an inner space of the outer tube 100 and an inner space of the end cap 200 and thus forms a parts housing space for housing respective parts. Moreover, the removal of the end cap 200 from the rear end portion of the outer tube 100 allows the parts such as the refill 300 to be taken out from the outer tube 100 for parts replacement (see FIG. 2).

As shown in FIGS. 1A and 2, the refill 300 is housed in an inner space of the outer tube 100 and the end cap 200 so that the refill 300 extends linearly and the axis 300AX thereof is on the same straight line as an axis 100AX of the outer tube 100. The refill 300 includes: a paint housing part 310 for housing a paint; and a paint outlet part 320 provided on the tip side of the paint housing part 310. The paint from the paint housing part 310 is fed onto paper through the paint outlet part 320. Examples of such a paint include liquid paints such as an ink and a liquid eyeliner. Examples of such inks include raw inks (having a viscosity of 10 poise or lower, for example), gel inks (having a viscosity in a range of 100 poise to 3000 poise, for example), and high-viscosity inks (having a viscosity in a range of 10000 poise to 100000 poise, for example). Examples of the liquid eyeliners include oil-based type, water-based film type, and water-based non-film type liquid eyeliners.

Any paint housing part 310 may be employed such as of an ink absorber type in which an ink is held in a member such as a sponge, a porous material made of urethane, or a filling material formed by bundling fibers, or of a raw ink type in which an ink is directly housed in an ink tank.

The paint outlet part 320 includes: a nib 321; a guiding core (not shown) for feeding an ink from the paint housing part 310 to the nib 321; and a core holding part 322 for holding the nib 321 and the guiding core (intermediary core). This guiding core allows the flow of the paint between the paint housing part 310 and the nib 321. Examples of the nib 321 include a ballpoint pen type, a felt pen type using a fiber bundle, a plastic pen type having an ink guiding hole therein, a sintered pen type, a brush type, and a nib made of porous urethane.

Note that when the paint is solid, a refill having a solid paint provided at a tip thereof and a paint holding part for holding the solid paint may be employed.

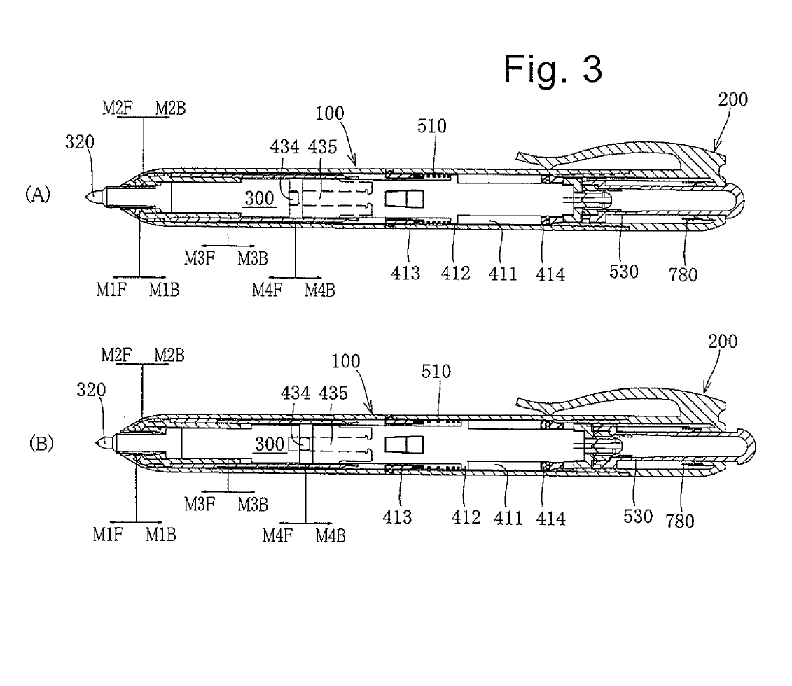

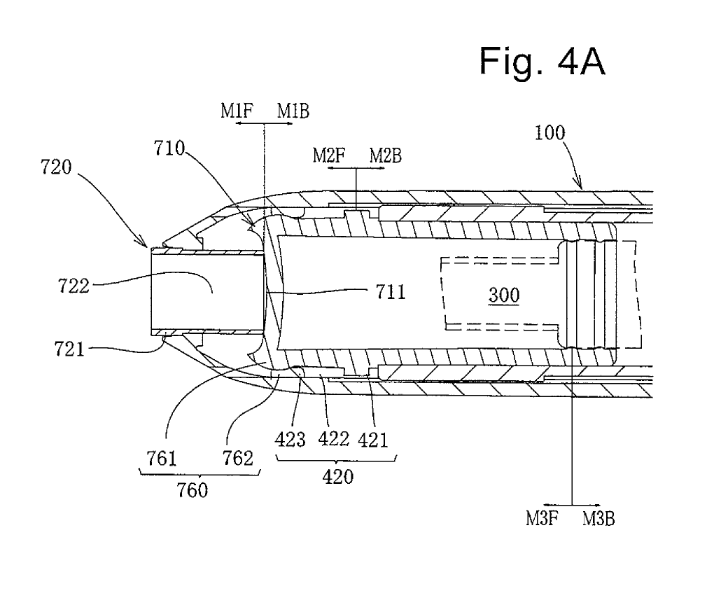

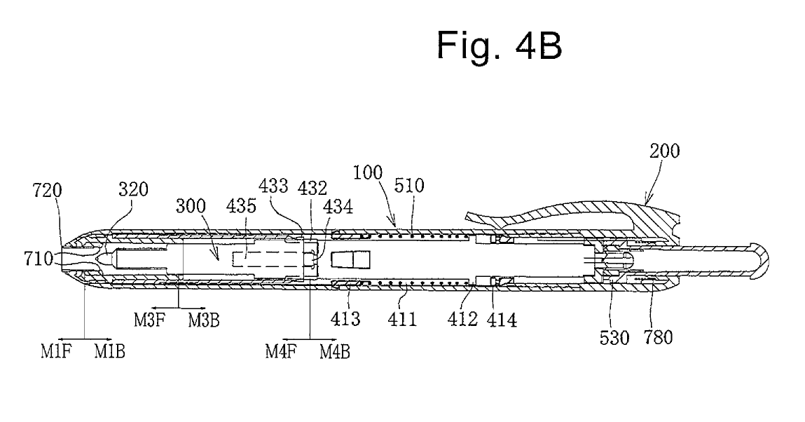

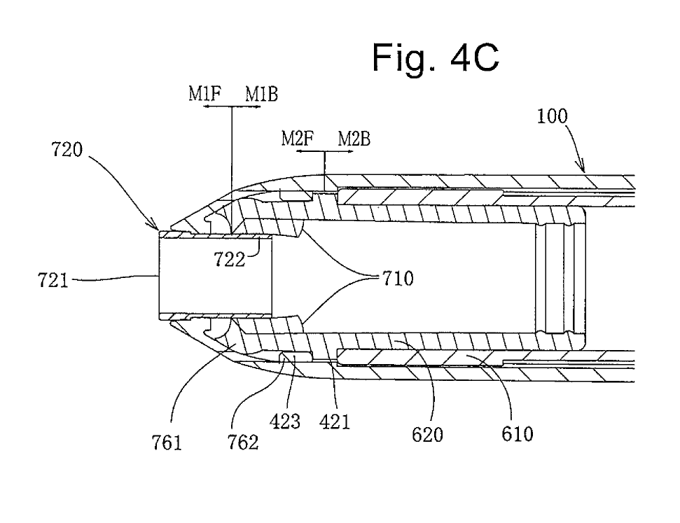

As shown in FIG. 1A, the refill moving mechanism 400 includes a projecting and retracting movement mechanism 410 configured to allow the refill 300 to be movable between a housed state in which the paint outlet part 320 is positioned inside the outer tube 100 (see FIGS. 1A and 4A to 4C) and a projecting state in which the paint outlet part 320 projects from an opening end of the outer tube 100 on the front end side thereof (see FIGS. 3(A) to 3(B)).

As shown in FIG. 1B, the projecting and retracting movement mechanism 410 includes: a tube inner groove 411 provided in an inner peripheral surface of the outer tube 100; a projecting and retracting guide protrusion 412 provided so as to protrude from an outer peripheral surface of the refill 300; a front end engagement part 413 provided at a front end of the tube inner groove 411; and a rear end engagement part 414 provided at a rear end of the tube inner groove 411. The tube inner groove 411 extends in the direction of the axis 300AX. The rear end engagement part 414 is provided in a knocking operation part movement hole 200X to be described later. The projecting and retracting guide protrusion 412 is movable along the tube inner groove 411. The projecting and retracting guide protrusion 412 engages with the front end engagement part 413 via a main spring 510 to be described later at a front end thereof, and is locked by the rear end engagement part 414 at a rear end thereof. When the projecting and retracting guide protrusion 412 approaches the front end engagement part 413, the refill 300 assumes the projecting state (see FIGS. 3(A) to 3(B)). When the projecting and retracting guide protrusion 412 moves away from the front end engagement part 413 and approaches the rear end engagement part 414, the refill 300 assumes the housed state (see FIGS. 1A and 4A to 4C). Thus, the projecting and retracting movement mechanism 410 allows the refill 300 to be movable between the housed state and the projecting state.

As shown in FIG. 1A, the knocking operation mechanism 500 includes: the main spring 510 disposed in the tube inner groove 411; a refill locking positioning mechanism 520 disposed in the end cap 200 while being fitted to the rear end portion of the refill 300; and a knocking operation part 530 fitted to the rear end side of the refill locking positioning mechanism 520.

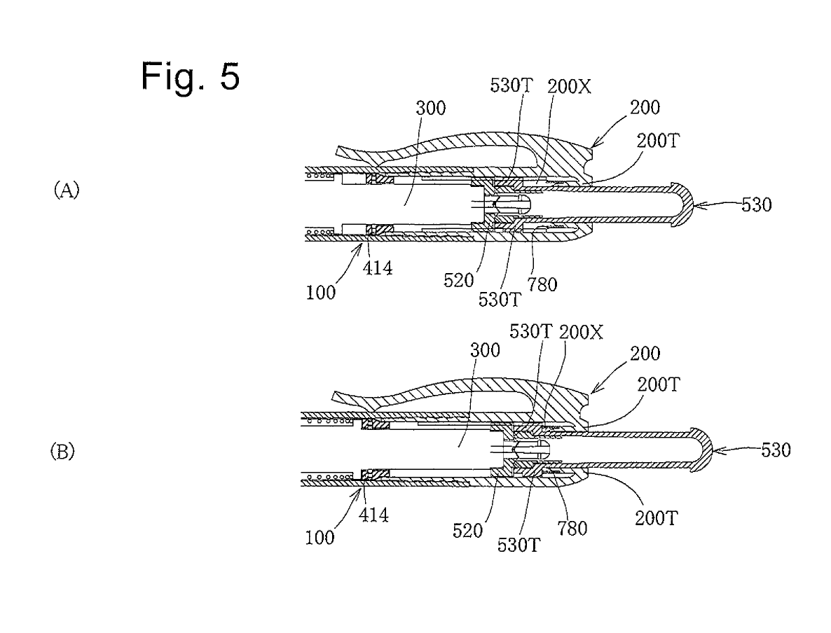

As shown in FIG. 5, the knocking operation part movement hole 200X is provided in the end cap 200 in communication with the inner space of the end cap 200. The knocking operation part movement hole 200X extends along the axis 300AX so as to open from a rear end face of the end cap 200. Moreover, the front side of the knocking operation part 530 is inserted into the knocking operation part movement hole 200X. Consequently, the knocking operation part 530 becomes movable in the front-back direction. Furthermore, the opening end of the knocking operation part movement hole 200X is provided with a locking protrusion 200T, and a front end of the knocking operation part 530 is provided with a locking protrusion 530T capable of engaging with the locking protrusion 200T.

As shown in FIG. 1A, the main spring 510 engages with the front end engagement part 413 at a front end thereof, and engages with the front end side of the projecting and retracting guide protrusion 412 at a rear end thereof. When the refill 300 is moved forward by an operation of the knocking operation part 530, a backward biasing force resulting from the main spring 510 is generated in the refill 300. The refill locking positioning mechanism 520 is switchable between a housed locking state for locking with the refill 300 in the housed state in the direction of the axis 300AX (see FIG. 1A) and a projecting locking state for locking with the refill 300 in the projecting state in the direction of the axis 300AX (see FIG. 3(B)). Such a knocking operation mechanism 500 allows the refill 300 to be alternately switchable between the housed locking state (see FIG. 1A) and the projecting locking state (see FIG. 3B).

As shown in FIGS. 1A to 1B, the knock-type writing instrument 2 further includes: an inner tube 600 disposed inside the outer tube 100, for holding the refill 300 by an inner peripheral portion thereof; an opening and closing device 710 provided on the front side of the inner tube 600 inside the outer tube 100; and a release device 720 disposed anterior to the opening and closing device 710 inside the outer tube 100.

The inner tube 600 includes a sliding tube 610 and an airtight tube 620. The airtight tube 620 is fixed to the sliding tube 610 with the rear end side thereof being inserted into an opening end of the sliding tube 610 on the front end side thereof.

The opening and closing device 710 is provided at an opening end of the airtight tube 620 on the front end side thereof. The opening and closing device 710 is formed in a circular disc shape and includes a linear slit 711 formed in a central portion thereof (see FIGS. 1C and 5). The opening and closing device 710 as a whole preferably has a shape protruding toward its rear end side. Note that the slit 711 is not limited to such a linear shape and another shape, such as a shape in which two linear lines are intersected with each other, may be used. In order to reliably obtain a closed state, however, the linear shape is preferable.

The slit 711 extends so as to traverse a moving path 300R of the refill 300 by the refill moving mechanism 400. A material for forming the opening and closing device 710 is preferably an elastic material such as rubber or a silicone resin.

Note that materials for forming other parts such as the outer tube 100, the end cap 200, the sliding tube 610, the knocking operation part 530, and the release device 720 include synthetic resins such as PP (polypropylene), PE (polyethylene), PET (polyethylene terephthalate), PET (polybutylene terephthalate), nylon, polyester, PMMA (polymethyl methacrylate), ABS (acrylonitrile), POM (polyacetal), and PC (polycarbonate), for example.

As shown in FIGS. 1C and 5, the release device 720 includes: a fitted ring 721 fitted into a front end-side opening in the outer tube 100; and a release ring 722 extending from the fitted ring 721 toward the rear end side. The release ring 722 is disposed so that a rear end thereof directly faces the opening and closing device 710 and the moving path 300R of the refill 300 passes through a hollow portion thereof. Note that the slit 711 preferably extends so as to traverse the release ring 722 as viewed from the direction of the axis 300AX. Moreover, a housing space 100K of the opening and closing device 710 is formed between the inner peripheral surface of the outer tube 100 and the release device 720. Furthermore, the outer tube 100 preferably includes a communication hole 100L which allows communication between the external space of the outer tube 100 and the housing space 100K. The housing space 100K and the communication hole 100L allow smoother switching of the opening and closing device 100 between an open state and a closed state to be described later.

In conjunction with the refill moving mechanism 400 (see FIG. 1A), the opening and closing device 710 can transition between a state in which the opening and closing device 710 abuts against the release device 720 (hereinafter, it is referred to as an abutting state (see FIGS. 4A to 4C)) and a state in which the opening and closing device 710 is away from the release device 720 (hereinafter, it is referred to as a separated state, and see FIG. 1C). In the abutting state, the opening and closing device 710 deforms toward the rear end side due to the abutting against the release ring 722. Consequently, the slit 711 is opened. Thus, the slit 711 assumes the open state in which the refill 300 can pass therethrough (see FIGS. 4B to 4C). In the state in which the opening and closing device 710 is away from the release device 720, the slit 711 assumes the closed state (see FIG. 1C).

As shown in FIG. 1C, an airtight rib 640 is provided so as to protrude on an inner peripheral surface of the airtight tube 620. The airtight rib 640 is configured to fill a gap between the airtight tube 620 and the refill 300 inserted into the airtight tube 620. Thus, the airtight tube 620, the airtight rib 640, and the opening and closing device 710 in the closed state together constitute an airtight mechanism 650 which turns a space around the paint outlet part 320 to a sealed space.

As shown in FIG. 1A, the refill moving mechanism 400 includes: an outer tube-side moving mechanism 420 that allows the refill 300 and the inner tube 600 to be movable relative to the outer tube 100; and an inner tube-side moving mechanism 430 which allows the refill 300 to be movable relative to the inner tube 600.

As shown in FIG. 2, the inner tube-side moving mechanism 430 includes: a sliding surface 431 formed on the outer peripheral surface of the refill 300 so as to be slidable with respect to an inner peripheral surface 611 of the sliding tube 610; a refill-side protruded rib 432 provided so as to protrude from the sliding surface 431; a sliding tube-side locking piece 433 provided so as to extend backward from a rear end face of the sliding tube 610; a refill-side guide protrusion 434 provided so as to protrude from the refill-side protruded rib 432; and a sliding tube-side guide groove 435 extending in the direction of the axis 300AX in the sliding tube 610.

The refill-side protruded rib 432 extends in a circumferential direction of the refill 300.

A connection between the sliding tube 610 and the sliding tube-side locking piece 433 has a thickness thinner than those of the sliding tube 610 and the sliding tube-side locking piece 433. Thus, the sliding tube-side locking piece 433 is deformable so as to spread outward in a radial direction with respect to the sliding tube 610. In other words, the sliding tube-side locking piece 433 is deformable between a state in which the sliding tube-side locking piece 433 is positioned on a moving path of the refill-side protruded rib 432 and a state in which the sliding tube-side locking piece 433 is deviated from the moving path of the refill-side protruded rib 432. In the state in which the sliding tube-side locking piece 433 is positioned on the moving path of the refill-side protruded rib 432, the sliding tube-side locking piece 433 can engage with the refill-side protruded rib 432, and the refill 300 is thus locked on the front side thereof (see FIG. 1A). In the state in which the sliding tube-side locking piece 433 is deviated from the moving path of the refill-side protruded rib 432, on the other hand, the refill 300 can be moved freely in the direction of the axis 300AX since no sliding tube-side locking piece 433 engages with the refill-side protruded rib 432.

Since the refill-side guide protrusion 434 can engage with the sliding tube-side guide groove 435, the refill-side guide protrusion 434 and the sliding tube-side guide groove 435 together allow the refill 300 in a state held by the inner peripheral surface 611 of the sliding tube 610 to be movable in the direction of the axis 300AX (see FIGS. 1A and 3).

As shown in FIG. 1C, the outer tube-side moving mechanism 420 includes: an airtight tube-side guide protrusion 421 provided so as to protrude from an outer peripheral surface of the airtight tube 620; an outer tube-side guide groove 422 provided on the inner peripheral surface of the outer tube 100 so as to allow the airtight tube-side guide protrusion 421 to be movable in the direction of the axis 300AX; and a movement restricting protrusion 423 for restricting movement of the outer tube-side guide groove 422 and the airtight tube-side guide protrusion 421. Moreover, the movement restricting protrusion 423 is provided on the front end side of the outer tube-side guide groove 422. Furthermore, the movement restricting protrusion 423 is preferably capable of engaging with the airtight tube-side guide protrusion 421.

Thus, the outer tube-side moving mechanism 420 allows the refill 300 to be movable among a separated position (see FIG. 1C), a first abutting position (see FIG. 4A) at which the release device 720 abuts against the opening and closing device 710 but the slit 711 is in the closed state, and a second abutting position (see FIGS. 4B to 4C) at which the release device 720 abuts against the opening and closing device 710 and the slit 711 is in the open state. Note that the opening and closing device 710 is housed in the housing space 100K at this second abutting position while the slit 711 is in the open state.

As shown in FIG. 1C, the knock-type writing instrument 2 further includes a slit opening and closing lock mechanism 760. The slit opening and closing lock mechanism 760 includes: an opening and closing device-side protruded ring 761 provided along an outer circumference of the opening and closing device 710; and an outer tube-side protruded part 762 provided on the inner peripheral surface of the outer tube 100. The opening and closing device-side protruded ring 761 extends in a circumferential direction of the opening and closing device 710. The outer tube-side protruded part 762 is preferably formed integrally with the movement restricting protrusion 423.

Thus, when the refill 300 is at the separated position (see FIG. 1C), the opening and closing device-side protruded ring 761 firmly engages with the outer tube-side protruded part 762 (opening and closing restricted state). Consequently, outward deformation in the radial direction thereof is restricted in the opening and closing device 710. Thus, the slit 711 is maintained in the closed state. When the refill 300 is positioned at the first abutting position (see FIG. 4A), on the other hand, the opening and closing device-side protruded ring 761 weakly engages with the outer tube-side protruded part 762 (opening and closing restricted state). Consequently, the restriction for the deformation of the opening and closing device 710 is weakened. Furthermore, when the refill 300 is positioned at the second abutting position (see FIG. 4C), the opening and closing device-side protruded ring 761 is away from the outer tube-side protruded part 762 (opening and closing restriction retracted state). Consequently, the opening and closing device 710 is allowed to deform outward in the radial direction thereof. Thus, in the opening and closing restriction retracted state, abutting between the opening and closing device 710 and the release device 720 can easily open the slit 711. Moreover, at the second abutting position, the airtight mechanism 650 side parts (e.g., the airtight tube-side guide protrusion 421, the opening and closing device-side protruded ring 761, and the like) and the outer tube 100 side parts (e.g., the movement restricting protrusion 423 and the inner peripheral portion of the outer tube 100) are locked with respect to the front side.

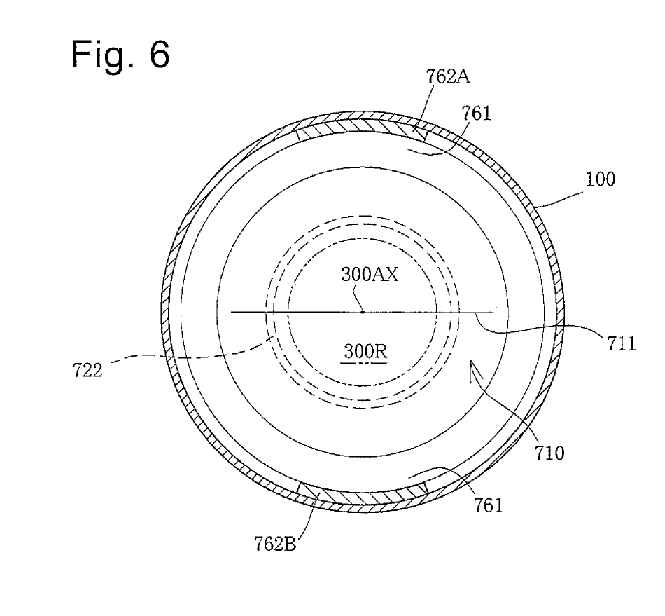

By the way, there is a case where an opening and closing operation of the slit 711 by the slit opening and closing lock mechanism 760 is not performed smoothly. For example, if a force from a direction oblique to the slit 711 is generated in the opening and closing device 710 by the slit opening and closing lock mechanism 760, the closed state for forming the sealed space may not be obtained. In such a case, the outer tube-side protruded part 762 is formed with the use of first and second outer tube-side protruded pieces 762A and 762B positioned away from each other (see FIG. 6). Furthermore, the first and second outer tube-side protruded pieces 762A and 762B are preferably disposed so as to face each other with reference to the slit 711. Due to such first and second outer tube-side protruded pieces 762A and 762B, a force in a direction orthogonal to the slit 711 is generated in the opening and closing device 710. Thus, the sealed space can be reliably formed.

As shown in FIGS. 1B and 5, the knock-type writing instrument 2 includes a buffer spring 780 for biasing the refill 300. The buffer spring 780 is housed in the knocking operation part movement hole 200X. A rear end of the buffer spring 780 is fixed to the end cap 200, and a front end thereof is formed as a free end. Thus, the refill 300 can transition between a buffer state (see FIG. 5(B)) in which the refill 300 receives a biasing force toward the projecting state from the buffer spring 780 and a retracted state (see FIG. 5(A)) in which the refill 300 is retracted from the buffer state.

Operations of the above-described embodiment will be described next. First, resistance forces M1x to M4x are defined as follows.

M1x: a frictional force of the opening and closing device 710 against the release device 720
M2x: a frictional force of the airtight tube 620 against the outer tube 100
M3x: a frictional force of the airtight tube 620 against the refill 300
M4x: a frictional force of the sliding tube 610 against the refill-side protruded rib 432
When the identifier “x” is replaced by “F,” it indicates a frictional force generated during a forward movement of the refill 300. When the identifier “x” is replaced by “B,” it indicates a frictional force generated during a backward movement of the refill 300.

<From housing locked state to separated position> If an operation of pushing the knocking operation part 530 is performed when the refill 300 is in the housing locked state, the locking of the knocking operation part 530 is released while maintaining the separated position (see FIG. 1A). Thus, the housing locked state is removed.

<From separated position to first abutting position> If the knocking operation part 530 is pushed further so as to move the refill 300 at the separated position (see FIG. 1A) forward, the resistance force (M3B+M4B) in the inner tube-side moving mechanism 430 is larger than the resistance force (M2B) in the outer tube-side moving mechanism 420. Therefore, in moving the refill 300 at the separated position (see FIG. 1A) forward, the refill 300 moves along the outer tube-side moving mechanism 420 to the first abutting position (see FIG. 4A) together with the inner tube 600 (the sliding tube 610 and the airtight tube 620).

<From first abutting position to second abutting position> If the knocking operation part 530 continues to be pushed further so as to move the refill 300 at the first abutting position (see FIG. 4A) forward, the resistance force (M3B+M4B) in the inner tube-side moving mechanism 430 is larger than the resistance force (M2B+M1B) in the outer tube-side moving mechanism 420. Therefore, in moving the refill 300 at the first abutting position (see FIG. 4A) forward, the refill 300 moves along the outer tube-side moving mechanism 420 to the second abutting position (see FIGS. 4B to 4C) together with the inner tube 600 (the sliding tube 610 and the airtight tube 620).

Here, at the second abutting position, the airtight mechanism 650 side parts (e.g., the airtight tube-side guide protrusion 421, the opening and closing device-side protruded ring 761, and the like) and the outer tube 100 side parts (e.g., the movement restricting protrusion 423 and the inner peripheral portion of the outer tube 100) engage with each other. Consequently, the refill 300 is locked with respect to the front side. Thus, when the refill 300 is moved from the first abutting position to the second abutting position, the resistance force (M1B+M2B) in the outer tube-side moving mechanism 420 increases.

<From second abutting position to projecting state> Furthermore, when the knocking operation part 530 is pushed further so as to move the refill 300 at the second abutting position (see FIGS. 4B to 4C) forward, the resistance force (M3B+M4B) in the inner tube-side moving mechanism 430 is smaller than the resistance force (M1B+M2B) in the outer tube-side moving mechanism 420. Therefore, in moving the refill 300 at the second abutting position (see FIGS. 4B to 4C) forward, the refill 300 moves along the inner tube-side moving mechanism 430. In other words, the refill 300 moves through the airtight tube 620. At this time, the opening and closing device 710 is abutting against the release device 720, and therefore the slit 711 is in the open state. Thus, the refill 300 passes through the slit 711 in the open state and eventually assumes the projecting state (see FIG. 3(A)) in which the paint outlet part 320 projects from the opening of the outer tube 100 at one end thereof.

<From projecting state to projecting locked state> Thereafter, when the operation of pushing the knocking operation part 530 is released, the refill 300 assumes the projecting locked state (see FIG. 3(B)) by the knocking operation part 530 while the refill 300 is biased toward the housed state by the main spring 510.

<From projecting locked state to projecting state> Next, when the operation of pushing the knocking operation part 530 is performed with respect to the refill 300 in the projecting locked state (see FIG. 3(B)), the refill 300 assumes the projecting state (see FIG. 3(A)). At this time, the locking by the knocking operation part 530 is also released.

<From projecting state to second abutting position> If the operation of pushing the knocking operation part 530 is released, the refill 300 is biased toward the housed state by the main spring 510. At this time, the movement restricting protrusion 423 engages with the airtight tube-side guide protrusion 421. Thus, when the refill 300 transitions from the projecting state to the second abutting position, the resistance force {M1F+M2F} in the outer tube-side moving mechanism 420 in the backward movement of the refill 300 increases. Thus, the resistance force {M1F+M2F} in the outer tube-side moving mechanism 420 in the backward movement of the refill 300 in the projecting state (see FIG. 3A) is larger than the resistance force (M4F+M3F) in the inner tube-side moving mechanism 430. Therefore, in moving the refill 300 in the projecting state (see FIG. 5A) backward, the refill 300 can be moved backward with respect to the airtight tube 620 until the refill-side guide protrusion 434 is locked with a rear end locking part 437 of the sliding tube-side guide groove 435. Thus, the refill 300 is moved from the projecting state to the housed state, more specifically, from the projecting state to the second abutting position (see FIGS. 4B to 4C).

<From second abutting position to first abutting position> If the refill-side guide protrusion 434 is locked with the rear end locking part 437 while the refill 300 is at the second abutting position (see FIGS. 4B to 4C), the resistance force {M1F+M2F} in the outer tube-side moving mechanism 420 in the backward movement of the refill 300 increases. Thus, when the refill 300 is at the second abutting position (see FIGS. 4B to 4C) and the refill-side guide protrusion 434 is locked with the rear end locking part 437, the resistance force {M1F+M2F} in the outer tube-side moving mechanism 420 in the backward movement of the refill 300 is larger than the resistance force (M3F+M4F) in the inner tube-side moving mechanism 430. Therefore, in moving the refill 300 in such a state backward, the refill 300 moves backward along the outer tube-side moving mechanism 420 together with the inner tube 600. Thus, the refill 300 is moved from the second abutting position (see FIGS. 4B to 4C) to the first abutting position (see FIG. 4A).

<From first abutting position to separated position> Also in a case where the refill 300 at the first abutting position (see FIG. 4A) is moved backward, the resistance force (M3F+M4F) in the inner tube-side moving mechanism 430 is larger than the resistance force {M1F+M2F} in the outer tube-side moving mechanism 420. Thus, in moving the refill 300 backward from the first abutting position (see FIG. 4A) to the separated position (see FIG. 1A), the refill 300 moves backward along the outer tube-side moving mechanism 420 together with the inner tube 600.

At this time, the refill 300 is biased toward the housing locked state by the main spring 510. Since the knock-type writing instrument 2 includes the buffer spring 780, the refill 300 having been biased toward the housing locked state is biased toward the projecting position by the buffer spring 780 without colliding against the farthest position in the outer tube 100 at high speed. Thus, the refill 300 moves slowly to the farthest position in the outer tube 100 and the refill 300 is prevented from colliding against the farthest position in the outer tube 100 at high speed. Therefore, a pressure fluctuation in the refill 300 due to such collision can be prevented, and thus ink leakage and scattering induced by such a pressure fluctuation in the refill 300 can be reliably prevented from occurring.

In this manner, according to the knock-type writing instrument 2, the movement of the refill 300 can achieve formation and removal of the sealed state around the paint outlet part 320 and switching between the housed state and the projecting state. Thus, when the knock-type writing instrument 2 is not used, the paint outlet part 320 can be housed in the outer tube 100 and the sealed space can be formed around the paint outlet part 320 by the operation of the knocking operation part 530. Consequently, it is possible to make the paint last long. Moreover, the operation of forming and removing the sealed state can be performed by causing the release device 720 provided in the outer tube 100 to abut against the opening and closing device 710. Thus, an ink is prevented from attaching to the opening and closing device 710 due to such an operation. Therefore, it is also possible to prevent a problem such as that the ink attached to the opening and closing device 710 hinders the smooth opening and closing operation of the slit 711.

During the movement of the refill 300 between the separated position (see FIG. 1A) and the second abutting position (see FIGS. 4B to 4C), the slit 711 is in the closed state and no relative movement between the sliding tube 610 and the airtight tube 620 occurs. Thus, a relative position between the sliding tube 610 and the airtight tube 620 does not change, i.e., a pressure in the sealed space formed around the paint outlet part 320 does not fluctuate. Therefore, a pressure fluctuation in the refill 300 due to a volume fluctuation in the sealed space can be prevented, and thus troubles induced by such a pressure fluctuation can be avoided. During the movement of the refill 300 between the second abutting position (see FIGS. 4B to 4C) and the projecting locked state (see FIG. 3(B)), on the other hand, the slit 711 is in the open state. Therefore, even when a relative position between the sliding tube 610 and the airtight tube 620 is changed, such a change will never induce a pressure fluctuation in the refill 300. Thus, the troubles induced by such a pressure fluctuation can be prevented from occurring.

Moreover, since the opening and closing device 710 as a whole has the shape protruding toward its rear end side, a relatively small force is sufficient when the release device 720 disposed on the front end side thereof is used for the transition of the opening and closing device 710 in the closed state to the open state. Furthermore, even if a pressure in the sealed space around the paint outlet part 320 is increased and therefore the portion which forms the slit 711 tries to deform forward, the closed state does not easily transition to the open state as a result of the engagement between the opening and closing device 710 and the release device 720. Thus, ink leakage or ink scattering due to the pressure increase in the sealed space around the paint outlet part 320 can be prevented from occurring.

Although the release device 720 is fixed to the outer tube 100 and the opening and closing device 710 is configured so as to be movable in the outer tube 100 in the above-described embodiment, the present invention is not limited thereto. The opening and closing device 710 may be fixed to the outer tube 100, and the release device 720 may be configured so as to be movable in the outer tube 100. Then, in order to move the release device 720 in the outer tube 100, a separate moving mechanism different from the refill moving mechanism 400 for moving the refill 300 may be provided.

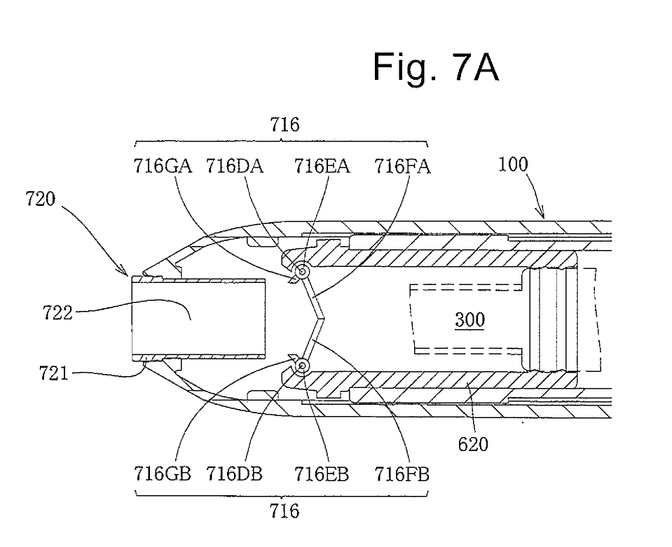

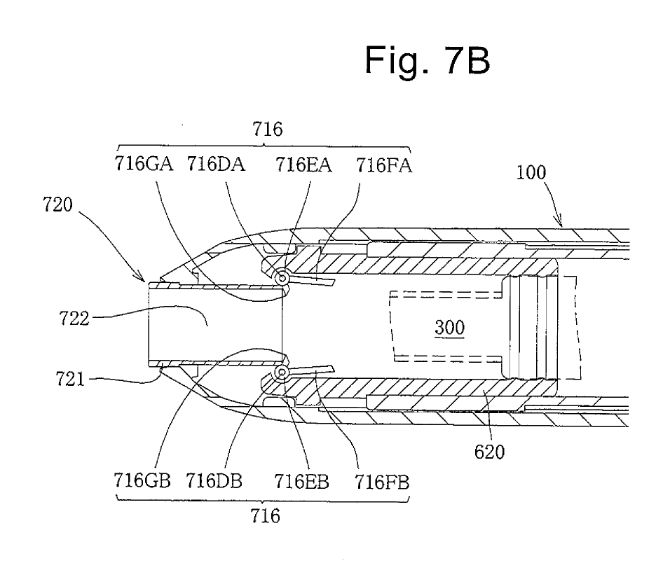

Although the opening and closing device 710 is switched between the open state and the closed state by switching between the state in which the release device 720 directly abuts against the opening and closing device 710 and the state in which the release device 720 is away from the opening and closing device 710 in the above-described embodiment, the present invention is not limited thereto. For example, if ink drying does not matter, an opening and closing device 716 shown in FIGS. 7A to 7B may be provided instead of the opening and closing device 710 as follows. The opening and closing device 716 may include: first and second swing shafts 716DA and 716DB provided at front end portions of the airtight tube 620; first and second swing tubes 716EA and 716EB rotatably attached to the first and second swing shafts 716DA and 716DB, respectively; first and second opening and closing protrusions 716FA and 716FB provided so as to protrude from outer peripheral surfaces of the first and second swing tubes 716EA and 716EB; and first and second engagement protrusions 716GA and 716GB provided so as to protrude from the outer peripheral surfaces of the first and second swing tubes 716EA and 716EB.

The first and second opening and closing protrusions 716FA and 716FB are configured so as to be swingable by the first and second swing shafts 716DA and 716DB between a rising state (see FIG. 7A) in which the first and second opening and closing protrusions 716FA and 716FB have risen from the inner peripheral surface of the airtight tube 620 and a tipped state (see FIG. 7B) in which the first and second opening and closing protrusions 716FA and 716FB have been tipped more backward than the rising state. Moreover, when the first and second opening and closing protrusions 716FA and 716FB are both in the rising state (see FIG. 7A), tips of the first and second opening and closing protrusions 716FA and 716FB are in contact with each other. Consequently, the opening and closing device 716 assumes a closed state in which an inner space of the airtight tube 620 is a sealed space. When the first and second opening and closing protrusions 716FA and 716FB are both in the tipped state (see FIG. 7B), on the other hand, the tips of the first and second opening and closing protrusions 716FA and 716FB are away from each other. Consequently, the opening and closing device 716 assumes an open state in which the refill 300 can pass therethrough.

When the first and second opening and closing protrusions 716FA and 716FB are in the rising state (see FIG. 7(A)), the first and second engagement protrusions 716GA and 716GB extend toward the opening and closing device 720, i.e., the front side as compared to the first and second opening and closing protrusions 716FA and 716FB. Moreover, since the first and second engagement protrusions 716GA and 716GB are rotatably attached to the first and second swing shafts 716DA and 716DB, respectively, the first and second engagement protrusions 716GA and 716GB swing integrally with the first and second opening and closing protrusions 716FA and 716FB. Furthermore, in both of the rising state (see FIG. 7A) and the tipped state (see FIG. 7B), the first and second engagement protrusions 716GA and 716GB are retracted from the moving path (not shown) of the refill 300. Therefore, the first and second opening and closing protrusions 716FA and 716FB transition between the rising state (see FIG. 7A) and the tipped state (see FIG. 7B) by the first and second engagement protrusions 716GA and 716 GB brought into contact with the release device 720 (see FIG. 7(A)) and by the first and second engagement protrusions 716GA and 716GB moved away from the release device 720 (see FIG. 7(B)). Thus, the opening and closing device 710 is switched between the open state (see FIG. 7(A)) and the closed state (see FIG. 7(B)).

In addition to writing instruments such as stationery, the knock-type writing instrument 2 of the present invention can be used also as a makeup tool such as an eyeline marker. Thus, writing objects include a variety of objects such as paper, skin, and body hair. Note that both of the front and rear ends of the buffer spring 780 may be formed as free ends. When both of the front and rear ends of the buffer spring 780 are formed as fixed ends, the biasing force of the buffer spring 780 is preferably made smaller than that of the main spring 510. Furthermore, the buffer spring 780 may be disposed between the projecting and retracting guide protrusion 412 and the rear end engagement part 414 instead of being disposed in the end cap 200.

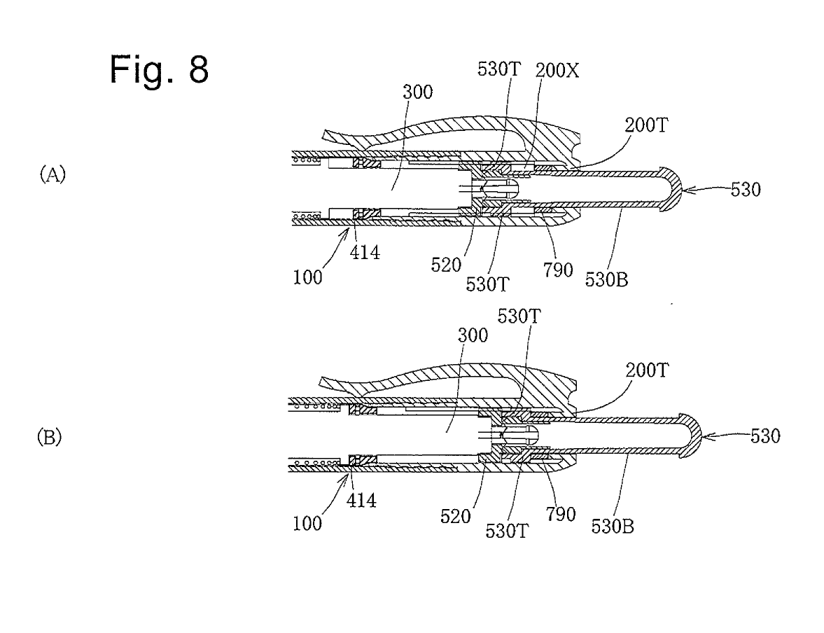

Although the refill 300 having been biased toward the housing locked state is biased toward the projecting position by the buffer spring 780 as shown in FIG. 5 in the above-described embodiment, the present invention is not limited thereto. For example, as shown in FIG. 8, an elastic tube 790 may be used instead of the buffer spring 780. The elastic tube 790 is housed in the knocking operation part movement hole 200X. A rear end of the elastic tube 790 is fixed to the end cap 200, and a front end thereof is formed as a free end. Therefore, the refill 300 can transition between a buffer state (see FIG. 8(B)) in which the refill 300 receives a biasing force toward the projecting state from the elastic tube 790 and a retracted state (see FIG. 8(A)) in which the refill 300 is retracted from the buffer state. Thus, the elastic tube 790 can reduce the moving speed of the refill 300 biased toward the housing locked state by utilizing the elastic deformation of the elastic tube 790.

Furthermore, the knocking operation part 530 preferably includes a tube part 530B provided posterior to the locking protrusion 530T, and an inner peripheral surface of the elastic tube 790 preferably slides with an outer peripheral surface of the tube part 530B. A frictional force between the inner peripheral surface of the elastic tube 790 and the outer peripheral surface of the tube part 530B can reduce the moving speed of the refill 300 biased toward the housing locked state.

A portion of the tube part 530B which slides with the inner peripheral surface of the elastic tube 790 is preferably provided in a front end of the tube part 530B. For example, an outer diameter of the tube part 530B is preferably decreased gradually, starting from a size capable of sliding with the inner peripheral surface of the elastic tube 790, from the front end side toward the rear end side.

The refill 300 including the paint housing part 310 and the paint outlet part 320 has been described in the above-described embodiment (see FIGS. 1A and 2). By the way, when a raw ink or the like having a low viscosity is used as a paint, the behavior of such a paint is sensitive to a pressure fluctuation in the paint housing part 310. Therefore, troubles occur due to factors which cause a pressure fluctuation in the paint housing part 310 (e.g., a temperature change in the external environment, a pressure change, a knocking operation, and the like). For example, when a pressure in the paint housing part 310 is increased, the paint leaks from the paint outlet part 320. Conversely, when a pressure in the paint housing part 310 is decreased, no paint is fed from the paint outlet part 320 and therefore writing becomes impossible. In view of this, it is preferable that the refill further include a pressure fluctuation buffering part for buffering a pressure fluctuation in the paint housing part 310.

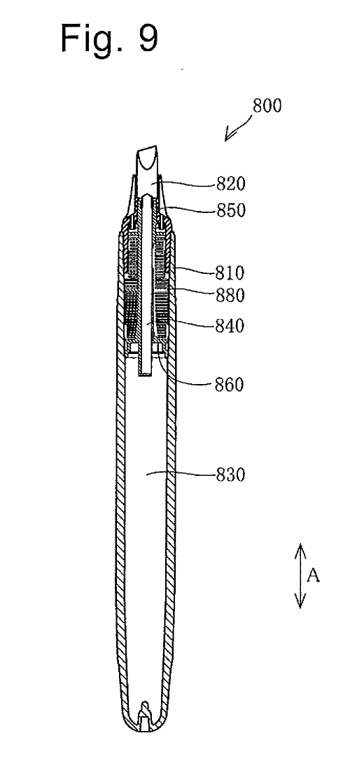

With reference to FIGS. 9 to 14, a refill 800 including the pressure fluctuation buffering part will be described below.

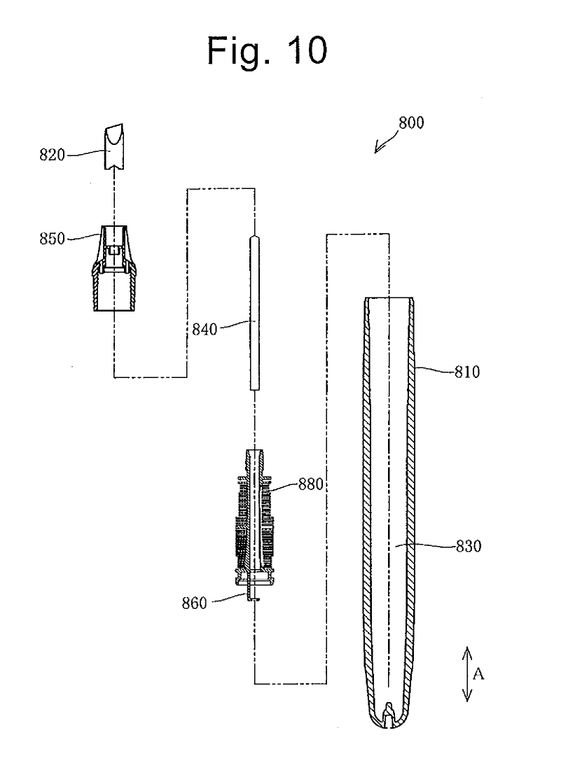

As shown in FIGS. 9 to 10, a refill 800 includes: a cylindrical barrel 810; a nib 820 disposed on the front end side of the barrel 810; a paint tank 830 formed on the rear end side of the barrel 810; a paint feeder 840 for feeding a paint to the nib 820; a brush holding member 850 attached to the barrel 810 for holding the nib 820; a paint feeder holding tube 860 disposed in an inner space of the barrel 810 for holding the paint feeder 840; and a pressure fluctuation buffering mechanism 880 for buffering a pressure fluctuation in the paint tank 830. Here, the paint tank 830 functions as the paint housing part 310 (see FIG. 2), and the nib 820 functions as the nib 321 (see FIG. 2) of the paint outlet part 320. The brush holding member 850 and the paint feeder holding tube 860 function as the core holding part 322 (see FIG. 2) of the paint outlet part 320.

The paint feeder 840 is formed in a rod shape, and extends from an inner space of the paint tank 830 to the nib 820 through the inner space of the barrel 810. A front end of the paint feeder 840 is stuck into the nib 820, and a rear end of the paint feeder 840 is exposed to the inner space of the paint tank 830. Thus, the paint feeder 840 can feed the paint housed in the paint tank 830 to the nib 820. Any material such as a sponge or a porous material made of urethane may be employed as the paint feeder 840.

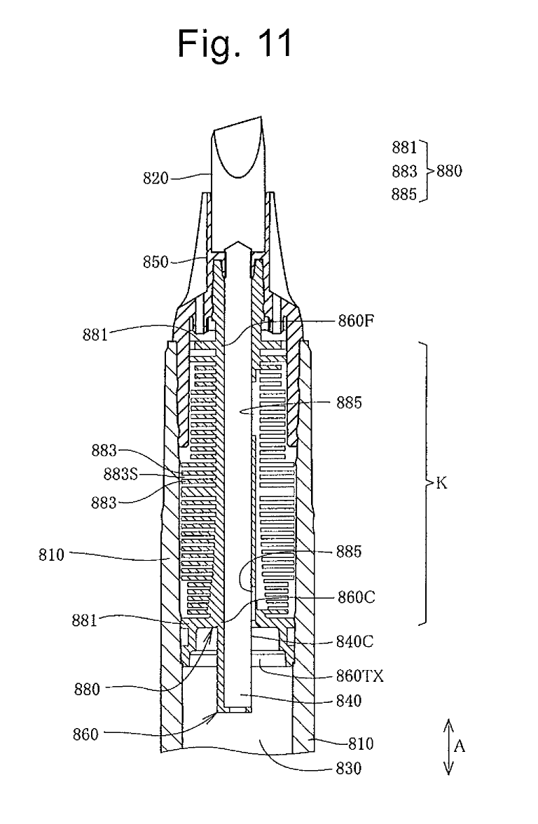

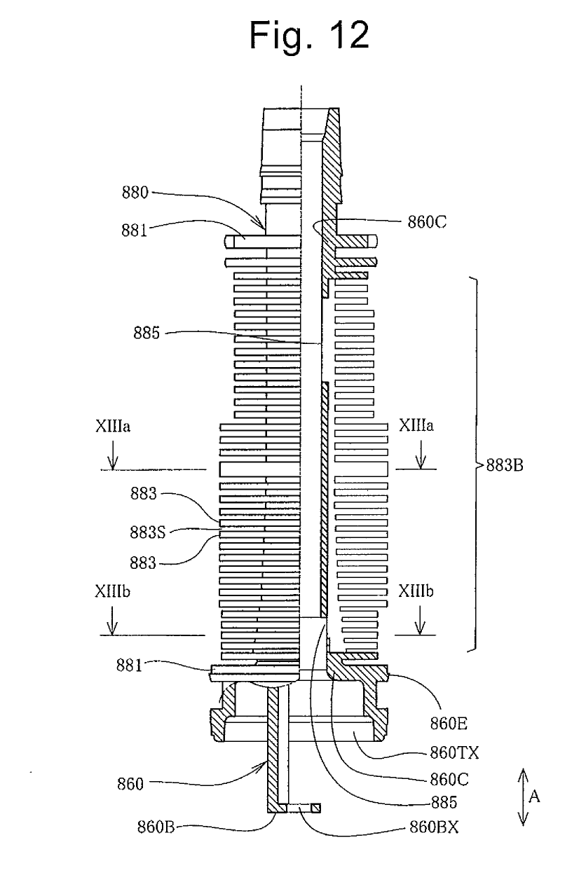

As shown in FIGS. 11 to 12, the pressure fluctuation buffering mechanism 880 is configured so as to form a connected space K directly or indirectly in communication with the paint tank 830. The pressure fluctuation buffering mechanism 880 is formed integrally with the paint feeder holding tube 860. The pressure fluctuation buffering mechanism 880 includes: connected space forming members 881 for forming the connected space K; a plurality of protruded plates 883 each formed in a circular ring shape; and a connection channel 885 which allows communication between the connected space K and an inner space of the paint feeder holding tube 860.

The connected space forming members 881 are provided side by side in the paint feeder holding tube 860 with a predetermined interval therebetween in an axial direction A. For example, the first connected space forming member 881 is provided in a front end portion 860F of the paint feeder holding tube 860, and the second connected space forming member 881 is provided in an intermediate part 860C of the paint feeder holding tube 860. These connected space forming members 881 rise from an outer peripheral surface of the paint feeder holding tube 860 and extend toward an inner peripheral surface of the barrel 810. Thus, the connected space K is formed over a range from the outer peripheral surface of the paint feeder holding tube 860 and the inner peripheral surface of the barrel 810 between the two connected space forming members 881.

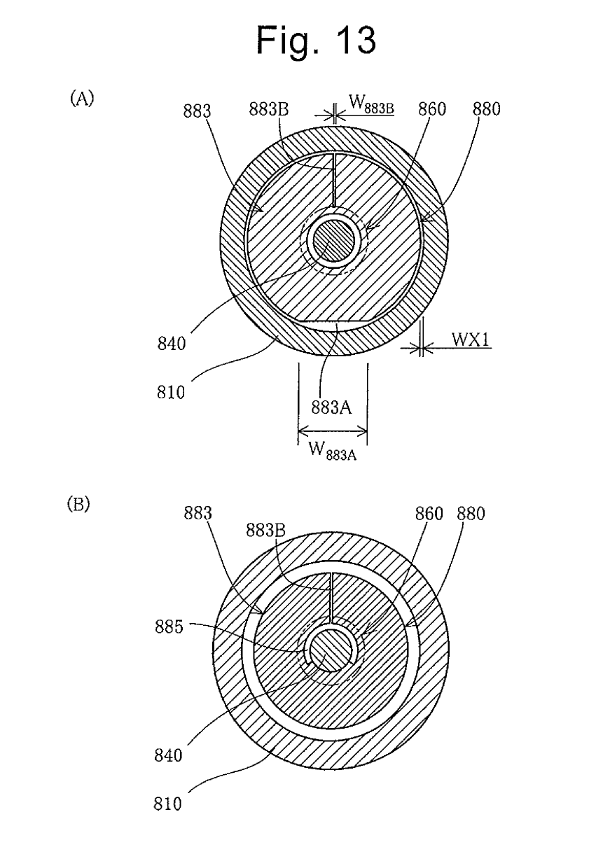

The plurality of protruded plates 883 are arranged side by side at predetermined intervals in the axial direction A. The plurality of protruded plates 883 rise from the outer peripheral surface of the paint feeder holding tube 860 and extend toward the inner peripheral surface of the barrel 810. In the connected space K, circumferential grooves 883S are each formed between adjacent two of the protruded plates 883. As shown in FIG. 13, the plurality of protruded plates 883 are each provided with an air cutout part 883A and a paint cutout part 883B. Note that the air cutout part 883A preferably faces the paint cutout part 883B with the paint feeder 840 interposed therebetween.

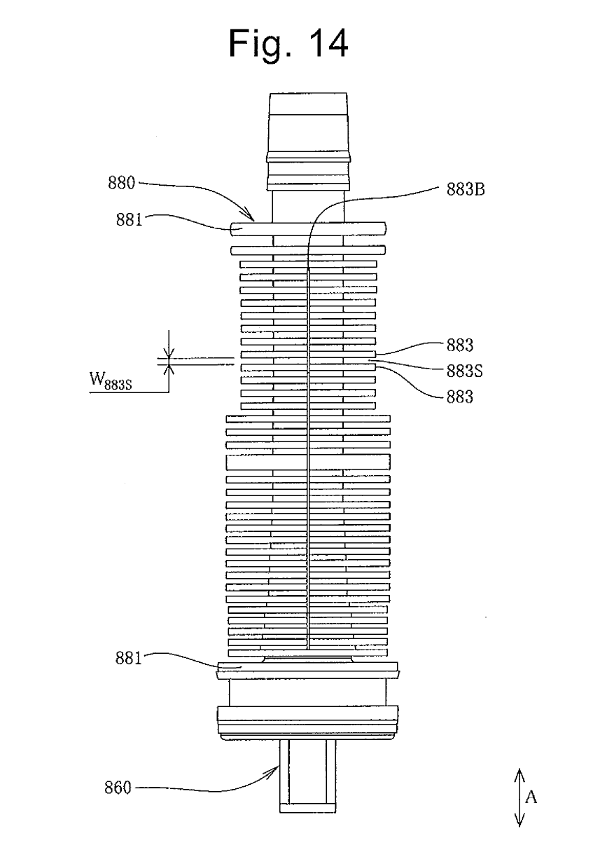

As shown in FIG. 14, the paint cutout parts 883B provided in the plurality of protruded plates 883 are lined in the axial direction A. A width W_{883S} of the circumferential groove 883S and a width W_{883B} (see FIG. 13) of the paint cutout part 883B are set so that the paint can enter these areas due to capillary force. In other words, the paint cutout parts 883B and portions of the circumferential grooves 883S each positioned between adjacent two of the paint cutout parts 883B function as a paint communication groove in the connected space K.

As shown in FIG. 13, the air cutout parts 883A provided in the plurality of protruded plates 883 are lined in the axial direction A in the plurality of protruded plates 883. The air cutout parts 883A and portions of the circumferential grooves 883S each positioned between adjacent two of the air cutout parts 883A function as an air communication groove in the connected space K.

Thus, when the refill 800 including the pressure fluctuation buffering part is employed, the paint communication groove and the air communication groove are formed in the connected space K of the knock-type writing instrument. Therefore, even if a factor which causes a pressure increase in the paint housing part 310 (e.g., a temperature increase in the external environment or a pressure increase) is generated, excess paint flows into the paint communication groove. Consequently, a pressure in the paint housing part 310 is prevented from increasing. Moreover, even if a factor which causes a pressure decrease in the paint housing part 310 (e.g., a temperature decrease in the external environment or a pressure phenomenon) is generated, excess air flows into the air communication groove. Consequently, a pressure in the paint housing part 310 is prevented from increasing. Thus, even if a factor of a pressure fluctuation in the paint housing part 310 is generated, paint leakage in the paint outlet part 320 or a phenomenon in which an amount of paint sufficient for writing cannot be fed can be prevented from occurring.

As shown in FIGS. 11 and 13, the connection channel 885 allows communication between the paint cutout part 883B and the inner space of the paint feeder holding tube 860. The connection channel 885 allows a paint flow between the paint feeder 840 inserted into the paint feeder holding tube 860 and the connected space K. Note that the number of the connection channels 885 may be one or two or more.

As shown in FIG. 12, the paint feeder holding tube 860 further includes an airtight part 860E and a paint tank communication channel 860TX. The airtight part 860E has an airtight surface in intimate contact with the inner peripheral surface of the barrel 810. The airtight part 860E is provided on a peripheral surface of the rear-side connected space forming member 881. One end of the paint tank communication channel 860TX is opened to the connection channel 885, and the other end thereof is opened to the paint tank 830 (see FIG. 11). Therefore, the paint tank communication channel 860TX achieves communication between the connection channel 885 and the paint tank 830. Furthermore, the paint tank communication channel 860TX allows a peripheral surface of an intermediate rod part 840C of the paint feeder 840 to be communicated with the paint tank 830. Therefore, the paint tank communication channel 860TX allows a paint and air to flow between the paint feeder 840 and the paint tank 830. Note that a depressed portion formed on an inner peripheral surface of the paint feeder holding tube 860 may be used as the paint tank communication channel 860TX.

It is to be noted that the present invention is not limited to the above-described embodiments, and various modifications can be made thereto without departing from the scope of the present invention.

1. A knock-type applicator including an applicator body having a paint outlet part for outputting a paint housed in a paint housing part to the outside,
the knock-type applicator configured to feed the paint outputted from the paint housing part to a material to be applied by causing the paint outlet part to abut against the material to be applied,
the knock-type applicator comprising:
an outer tube that houses the applicator body;
an applicator body moving mechanism configured to allow the applicator body to be movable between a housed state in which the paint outlet part is positioned in the outer tube and a projecting state in which the paint outlet part is projected from the outer tube; and
a paint outlet housing space forming mechanism configured to form a space in which the paint outlet part is housed, wherein
when the applicator body is in the housed state, the space in which the paint outlet part is housed assumes a sealed state, and
when the applicator body is in the projecting state, the space in which the paint outlet part is housed assumes an open state opened to an external space.

2. The knock-type applicator according to claim 1, wherein when the applicator body is in the housed state, a pressure change in the space in which the paint outlet part is housed is restricted.

3. The knock-type applicator according to claim 1, further comprising a pressure fluctuation buffering mechanism including a connected space directly or indirectly connected to the paint housing part and configured to suppress a pressure fluctuation in the paint housing part by flows of air and the paint between the connected space and the paint housing part.

4. The knock-type applicator according to claim 3, wherein a state in which a relative position between the applicator body and the paint outlet housing space forming mechanism is changeable and a state in which the relative position is restricted from changing is switchable therebetween.

5. The knock-type applicator according to claim 4, wherein switching between the state in which the relative position between the applicator body and the paint outlet housing space forming mechanism is changeable and the state in which the relative position is restricted from changing is performed by relative movement of the applicator body with respect to the outer tube.

6. The knock-type applicator according to claim 3, wherein when the applicator body is in the housed state, a relative position between the applicator body and the paint outlet housing space forming mechanism is restricted from changing.

7. The knock-type applicator according to claim 6, wherein when the paint outlet part is in the projecting state, the relative position between the applicator body and the paint outlet housing space forming mechanism is changeable.

8. The knock-type applicator according to claim 4, wherein when the applicator body is in the housed state, the relative position between the outer tube and the paint outlet housing space forming mechanism is changeable.

9. The knock-type applicator according to claim 4, wherein when the applicator body is in the projecting state, the relative position between the outer tube and the paint outlet housing space forming mechanism is restricted from changing.

10. The knock-type applicator according to claim 1, wherein the paint outlet housing space forming mechanism includes:
an opening and closing device having an opening and closing port configured to allow the space in which the paint outlet part is housed to be switchable between the sealed state and the open state; and
an airtight tube having the opening and closing device at one of opening ends thereof and the applicator body inserted from the other one of the opening ends thereof, and
the opening and closing device and the airtight tube are fixed to each other.

11. The knock-type applicator according to claim 3, wherein the paint outlet housing space forming mechanism includes:
an opening and closing device having an opening and closing port configured to allow the space in which the paint outlet part is housed to be switchable between the sealed state and the open state; and
an airtight tube having the opening and closing device at one of opening ends thereof and the applicator body inserted from the other one of the opening ends thereof, and
the opening and closing device is formed integrally with the airtight tube.

12. The knock-type applicator according to claim 3, wherein the paint outlet housing space forming mechanism includes an opening and closing device having an opening and closing port configured to allow the space in which the paint outlet part is housed to be switchable between the sealed state and the open state and formed in a slit shape.

13. A knock-type applicator including an applicator body having a paint outlet part for outputting a paint housed in a paint housing part to the outside,
the knock-type applicator configured to feed the paint outputted from the paint housing part to a material to be applied by causing the paint outlet part to abut against the material to be applied, the knock-type applicator comprising:
an outer tube that houses the applicator body;
an applicator body moving mechanism configured to allow the applicator body to be movable between a housed state in which the paint outlet part is positioned in the outer tube and a projecting state in which the paint outlet part is projected from the outer tube;
a paint outlet housing space forming mechanism configured to form a space in which the paint outlet part is housed; and
an opening and closing switching mechanism configured to allow the space in which the paint outlet part is housed to be switchable between a sealed state and an open state, wherein
the paint outlet housing space forming mechanism includes an opening and closing device having an opening and closing port configured to allow the space in which the paint outlet part is housed to be switchable between the sealed state and the open state and formed in a slit shape,
the opening and closing switching mechanism includes a release device that performs an opening and closing operation of the opening and closing device, and
the opening and closing port assumes an open state in which the paint outlet part can pass therethrough by the opening and closing operation.

14. The knock-type applicator according to claim 10, wherein:
the opening and closing device is disposed in the outer tube so as to traverse a moving path of the paint outlet part between the housed state and the projecting state; and
the release device is disposed at a position in the outer tube closer to one side than the opening and closing device so as to be deviated from the moving path of the paint outlet part, and performs relative movement to the opening and closing device.

15. The knock-type applicator according to claim 14, wherein the relative movement of the release device with respect to the opening and closing device is performed along with movement of the applicator body.

16. (canceled)

17. The knock-type applicator according to claim 10, further comprising:
an airtight tube having the opening and closing device at one of opening ends thereof and the applicator body inserted from the other one of the opening ends thereof; and
a sealing part provided in a gap between the airtight tube and the applicator body, and wherein
the opening and closing device in a closed state, the airtight tube, and the sealing part cause the space in which the paint outlet part is housed to be a sealed space, and
the applicator body moving mechanism includes:
an outer tube-side moving mechanism configured to allow the applicator body, together with the airtight tube, to be movable relative to the outer tube between an abutting position at which the opening and closing device abuts against the release device and a separated position at which the opening and closing device is away from the release device; and
an airtight tube-side moving mechanism configured to allow the applicator body to be movable relative to the airtight tube between the housed state and the projecting state when the opening and closing port is turned to the open state by the abutting.

18. The knock-type applicator according to claim 17, wherein:
the outer tube-side moving mechanism is provided between the outer tube and the airtight tube; and
the airtight tube-side moving mechanism is provided between the airtight tube and the applicator body.

19. The knock-type applicator according to claim 17, comprising an outer tube-side movement restricting member provided between the outer tube and the airtight tube, the outer tube-side movement restricting member restricting movement of the applicator body based on the outer tube-side moving mechanism, and wherein
the outer tube-side moving mechanism is configured to allow the applicator body at the abutting position to be movable between a state in which the applicator body is locked with the outer tube-side movement restricting member and a state in which the applicator body is away from the outer tube-side movement restricting member.

20. The knock-type applicator according to claim 19, wherein
when the applicator body is locked with the outer tube-side movement restricting member, movement of the applicator body based on the airtight tube-side moving mechanism takes precedence over movement of the applicator body based on the outer tube-side moving mechanism, and
when the applicator body is away from the outer tube-side movement restricting member, movement of the applicator body based on the outer tube-side moving mechanism takes precedence over movement of the applicator body based on the airtight tube-side moving mechanism.

21. The knock-type applicator according to claim 20, wherein when the applicator body moves from the separated position toward the abutting position, a resistance force generated in the airtight tube-side moving mechanism is larger than a resistance force generated in the outer tube-side moving mechanism.

22. The knock-type applicator according to claim 20, wherein when the applicator body in the projecting state moves toward the housed state, a resistance force generated in the airtight tube-side moving mechanism is smaller than a resistance force generated in the outer tube-side moving mechanism.

23. The knock-type applicator according to claim 10, wherein the opening and closing device is formed so as to protrude toward the other side.

24. The knock-type applicator according to claim 13, further comprising an opening and closing port lock mechanism provided between the outer tube and the opening and closing device, the opening and closing port lock mechanism restricting the opening and closing port in the closed state from transitioning to the open state, and wherein
when the applicator body is at the separated position, the opening and closing port lock mechanism keeps the opening and closing device in the closed state, and when the applicator body is at the abutting position, on the other hand, the opening and closing port lock mechanism causes the opening and closing device to be capable of transitioning to the open state.

25. The knock-type applicator according to claim 24, wherein
when the opening and closing port lock mechanism engages with an outer peripheral portion of the opening and closing device, the applicator body is at the separated position, and when the opening and closing port lock mechanism is away from the outer peripheral portion of the opening and closing device, on the other hand, the applicator body is at the abutting position.

26. The knock-type applicator according to claim 24, wherein:
the opening and closing port lock mechanism includes a first locking member and a second locking member provided between the outer tube and the opening and closing device so as to be separated from each other; and
the first locking member and the second locking member are disposed so as to face each other with the opening and closing port in a straight shape interposed therebetween.

27. The knock-type applicator according to claim 1, comprising:
a one-side outer tube locking protrusion provided so as to protrude from an inner peripheral surface of the outer tube;
an other-side outer tube locking protrusion provided so as to protrude from the inner peripheral surface of the outer tube at a position closer to the other side than the one-side outer tube locking protrusion;
an applicator body locking protrusion protruded from the applicator body between the one-side outer tube locking protrusion and the other-side outer tube locking protrusion;
a housed state-side biasing member for biasing the applicator body toward the housed state with both ends thereof abutting against the one-side outer tube locking protrusion and the applicator body locking protrusion; and
a projecting state-side biasing member for biasing the applicator body toward the projecting state, and wherein
the applicator body is capable of transitioning between a buffer state in which the applicator body receives a biasing force toward the projecting state from the projecting state-side biasing member and a retracted state in which the applicator body is retracted from the buffer state.

28. The knock-type applicator according to claim 27, wherein
when the applicator body is in the projecting state, the projecting state-side biasing member is away from the applicator body, and
when the applicator body is in the housed state, the projecting state-side biasing member gives the biasing force toward the projecting state to the applicator body.

29. The knock-type applicator according to claim 13, wherein:
a housing space for housing the opening and closing device in the open state is formed between the outer tube and the release device; and
a communication hole configured to allow communication between the housing space and an external space of the outer tube is formed in the outer tube.
